(19) United States
(12) Patent Application Publication
(10) Pub. No.: US 2005/0146419 A1
(43) Pub. Date: Jul. 7, 2005

(54) Programmable restricted access food storage container and behavior modification assistant

(76) Inventor: Michael Porter, West Hollywood, CA (US)

Correspondence Address: CHRISTIE, PARKER & HALE, LLP, PO BOX 7068, PASADENA, CA, 91109-7068, US

(21) Appl. No.: 10/753,132

(22) Filed: Jan. 7, 2004

(51) Int. Cl. H04B 1/00; G05B 19/00

(52) U.S. Cl. 340/5.73; 340/5.28

(57) ABSTRACT

A programmable food storage container and behavior modification assistant, having an automatically closing and locking lid/door, and a programmable lock mechanism able to accept and store multiple defined sequential periods of inaccessibility of variable duration and frequency, and multiple defined periods of accessibility of variable duration and frequency. Use of the device mandates compliance with, and reinforcement of behavior consistent with, the user's desire to develop and adhere to a pattern of controlled and limited consumption of any products stored within the container. Addressing the problem left unsolved in the prior art (i.e., the inability of some consumers to resist impulses to consume, and the finite and consumable capacity of people to resist temptation), the device eliminates temptations regarding its contents, and thus eliminates wasteful consumption of the consumer's finite supply of willpower, or capacity to successfully resist an impulse to consume.

### FIELD OF THE INVENTION

This invention relates to the field of restricted access storage containers that enforce a schedule of accessibility upon their contents, and to the field of devices and systems intended to aid their users in modifying their behavior as it relates to the self-regulation of dietary consumption, and as it relates to the conservation and preservation of the user's finite supply of human willpower.

### PRIOR ART

It is known by those practiced in the art that human consumption of inappropriate quantities of certain products is detrimental to human health, and that failure to successfully self-regulate the consumption of such products negatively impacts the areas of human self-image, healthy weight maintenance, and general health. Examples of the types of such products include, but are not limited to, food (particularly, “junk food”), tobacco products, alcohol products, etc. It is also widely known that children are particularly susceptible to the development of inappropriate consumption patterns when provided with unlimited access to “junk food,” leading to current record levels of obesity and similar health problems in the United States, and contributing negatively to their health, longevity, self image, and feelings of well-being. The increasing commonness of obesity is of rising concern to medical professionals in developed nations.

Though these facts are well known, it is also known that a substantial percentage of the population maintains supplies of such products in their homes or offices, and that they do so with the intention and/or desire to self regulate their behavior, and avoid over consumption. Unfortunately, it is also known that a measurable and substantial percentage of the population fails in that effort. The number and popularity of diet related products available on the market is a testament to these known facts.

The desire for consumers to find a way to be able to have quantities of various products in their homes or offices, and yet to limit their own or others' usage or consumption of those products, is well known and there are many devices known in the prior art which attempt to assist consumers in that endeavor. Beyond the desired usage of such devices to enforce upon the user an appropriate consumption pattern, it is known that consumers wish to be able to modify their behavior and habits regarding the usage or consumption of such products, toward obtaining and developing better habits of consumption and strength of self discipline over time, thus diminishing the need for reliance on devices of this type, and increasing their chances for realizing their long term goals to better their lives and health.

None of the devices disclosed in the prior art are effective in mandating compliance with a desired consumption pattern, and in assisting the user in his or her efforts to not only control current consumption, but to develop better, more healthy, and more controlled patterns of consumption through successfully overcoming limited, controlled and conquerable impulses to consume.

In purchasing a device designed solely and specifically for the purpose of scheduling or restricting access to some product, the user acknowledges and expresses: 1 the desire that there be a schedule of accessibility and/or consumption durably imposed upon the contents of the device; 2 the existence of periods of physical and/or mental weakness wherein the user is unable or less likely to adhere to such a desired schedule without assistance; and 3 the intention to rely upon the purchased device to enforce the schedule.

Presumably, the user would purchase and activate such a device during a period when the user had his best intentions in mind, rather than during a period of weakness, intending to rely upon the device to enforce the desired schedule of consumption. The very purchase of the device indicates the user's recognition that he experiences recurring periods of weakness during which he is unable to control his conduct to make it conform to his best intentions.

Devices of this type which inherently and repeatedly present opportunities or temptations for the user to change, circumvent, or disable, the pre-defined access parameters during normal usage and/or at easily predictable intervals, fail in their designed and intended purpose because they cannot rigorously and strictly enforce the users desired and designed schedule of accessibility. Given that the user of such a device, in recognition of his own weakness, has purchased and is using a device designed solely and specifically for the purpose of scheduling access to some product, any situation or feature, inherent to the design of such a device, that repeatedly could tempt the user to, or provides any means to, access the contents of the device outside of the user's desired and defined schedule of accessibility, is an unacceptable failing weakness of a device that is designed purely to durably and repeatedly enforce a scope of behavior.

Full understanding of some of the fundamental problems left unsolved by the prior art is arrived from study of the science of human psychology. In particular, the inventor has identified, through the study of numerous recent scientific publications, a problematical human behavioral trait that directly undermines and contributes to the inevitable failure and ineffectuality of all prior art devices of this type. The fundamental unsolved problem is that the human supply of the will to self regulate: (a) is of a diminishable nature; (b) is replenished by rest; (c) can be conserved; and (d) can be exercised by means of a strictly limited, and thus easy to resist, opportunity to positively overcome temptation.

Specifically, scientific articles published in the field of human psychology confirm that the human capacity to resist temptation is finite and diminishing, such that the act of resisting a temptation or “opportunity for failure” diminishes the consumer's capacity to continue to resist future such temptations and opportunities. The more opportunities for failure (or temptations) a consumer confronts in his efforts to regulate consumption, the less capacity the consumer will retain to succeed in resisting other such opportunities, and the more likely it is that the consumer will fail in the long term effort to repeatedly regulate consumption and to develop better consumption habits through habituation and positive reinforcement.

In contrast, the published scientific articles confirm that when the human will is tested in a limited, measurable and controlled manner, the consumer's chances of successfully bypassing the immediate temptation are substantially increased. When exposed to a temptation that is momentary in nature, people are generally able to adhere to their self-defined best intentions concerning consumption of a tempting, available, or offered product. And the publications confirm that over time, the act of successfully resisting such temptations directly contributes by means of positive reinforcement and by repetitive habituation, to the development in the user an enhanced capacity to resist temptation, and an improved ability of the user to practice a more beneficial manner and habit of consumption.

Thus, the scientific studies confirm the idea that even if the user of a restricted access device which presents repeated and unnecessary opportunities for the user to change, circumvent or disable the pre-defined access parameters during normal usage and/or at easily predictable intervals is successful in resisting one of the opportunities, the user does so by means of the consumption of some part of his finite supply of the will to self regulate, and does thus become, after repeated attempts to resist such temptations, less and less able to resist additional opportunities and temptations. By repeatedly presenting such opportunities, and by creating the need to overcome them again and again in order to maintain the desired consumption schedule, such a device actually wears down the user's will to resist the presented temptations. Rather than assisting in the development of the ability to resist such opportunities and temptations, such a device will actually contribute to the occurrence, degree, and frequency of periods of weakness, and thus, in an self defeating cycle, to the inability of the user to resist the devices in-built opportunities and temptations to fail.

Devices presenting such opportunities are self defeating, and present opportunities and temptations that are too frequent, too numerous and too difficult to overcome over time, leading to failure. There are no prior art devices that address or solve this problem.

The periodical Journal of Personality and Social Psychology (1998. Vol. 74. No. 5, 1252-1265), published by the American Psychological Society, contains an article describing a study entitled Ego Depletion: Is the Active Self a Limited Resource? This series of studies and experiments, executed at Case Western University by Baumeister, Bratlavsky, Muraven, and Tice, measures the depletion of the subject's internal reservoir of will, and the resulting effects of this depletion upon the subject's ability to extend his or her ability to exercise this will upon secondary tasks. The results of the study show a decreased ability to exercise focused mental energy after temptation and other forms of depletive behavior have depleted this reservoir of mental energy. As stated in the section of the study titled Implications:
“Moreover, this resource (of mental energy) appears to be quite surprisingly limited. In study 1, for example, a mere 5 minutes of resisting temptation in the form of chocolate caused a reduction by half in how long people made themselves keep trying at unsolvable puzzles. It seems surprising to suggest that a few minutes of a laboratory task, especially one that was not described as excessively noxious or strenuous, would seriously deplete some important aspect of the self. Thus, these studies suggest that whatever is involved in choice and self-control is both an important and very limited resource. The activities of the self should perhaps be understood in general as having to make the most of a scarce and precious resource.”

This study puts forward and supports the idea that the energy of the human ego is of a diminishable nature, that it is easily depleted by events requiring the exercise of will, and that its depletion has negative effects upon the human ability to succeed at other tasks that require expenditure of this same common reservoir of energy, suggesting that this reservoir of the will is common and integral to human functions that require focus and discipline.

The periodical “Psychological bulletin (2000. Vol. 126. No 2, 247-259)”, published by the American Psychological Association, contains a study titled “Self-Regulation and Depletion of Limited Resources: Does Self-Control Resemble a Muscle?”. This study, executed at Case Western University by Muraven and Baumeister, finds that there is evidence that the human will to self-regulate is of a variably finite capacity, is diminished by use, and is replenished by rest. These findings show that repeated testings of, and subsequent expenditures of, the reserve of the human will to self regulate, results in the subjects being increasingly less able to resist subsequent temptations. As stated in the study's conclusion:
“People have only a limited capacity to control and alter their behavior, and this capacity appears to be vulnerable to depletion in the aftermath of strenuous use.” The conclusion further states that “when people squander their self-control strength in unproductive endeavors, they may find that their self-control breaks down in other unrelated spheres.”

This study refines the idea of the “diminishable and replenishable reservoir of the will to self regulate” by successfully testing to eliminate as factors in subject performance other effects such as learned helplessness, and mood. Additionally, this article describes other successful experiments showing that this reservoir of will is capable of being generally increased in capacity by reasonable and measured exercise over time, much like the strength of a skeletal muscle being built up by measured and correct exercise interspersed with periods of rest.

The article “Self-Defeating Behavior Patterns Among Normal Individuals: Review and Analysis of Common Self-Destructive Tendencies (1988, Vol. 104, No. 1,3-22) from the Psychological Bulletin of the American Psychological Association, studies and explains how and why normal human beings sometimes make choices that have obvious and negative impacts upon their own well being. The motivations exposed and discussed in this study include deliberate self-destruction (choosing to suffer), counter productive strategy (internal tradeoffs that appear to have some momentary benefit but are in the long run damaging), guilt motivated desire (self punishing behavior), and self-handicapping (doing things that reduce the likelihood of success at some evaluative task). A common denominator of these motivations is the involvement of the feelings of self-esteem of the subject. In some instances high self esteem may cause a person to set unrealistic goals at the onset of a chosen path so that when failure results, the blame can be placed upon the difficulty of the path chosen rather than upon the performance of the subject. In other instances, low self-esteem may cause a person to deliberately fail at some chosen task as a way to justify/prove their low opinion of themselves. In both instances, opportunities to fail are used by the subject in ways that have little or nothing to do with the actual task at hand.

This study shows and implies that the elimination or reduction and the control of failure opportunities does enable a person to more easily and more consistently resist counter productive impulses to fail, resulting not only in a better likelihood of a task completed, but in a more likely fulfillment of the best intentions of the person, and further resulting in increased feelings of self worth. Moreover, the study implies that a tool that controls and reduces the instances of opportunities to fail will help the user to resist the types of counter productive impulses that would otherwise cause them to subvert their best intentions.

These scientific references demonstrate that prior art devices which require the user to repeatedly resist temptation and to make decisions and take actions in order to use the device, or which do not provide for any exercise at all of the user's will, do not present a solution to this previously misunderstood social/psychological problem, nor do they incorporate a means to tap into, exploit and enhance a consumer's capacity to resist temptation as recognized and defined in the science of human behavior. Prior art devices which repeatedly rely upon the will of the user are self defeating. None of the prior art devices present the unique benefits and characteristics provided by the present invention.

The basic common principles of operation of the prior art inventions and the common limitations of their basic design features and components provides an efficient means to categorize them in terms of their efficacy, and to illuminate common physical details and shortcomings inherent to the device groups. There are essentially three different types of prior art devices, as follows:

Limited Access Container Prior Art Devices

The desire to regulate consumption through the storage of products in containers that allow only limited access is known in the prior art, and the prior art discloses containers that can be set to restrict access to its contents except at a specified time. U.S. Pat. No. 5,129,536 Robinson, Jul. 14, 1992, which discloses a TIME ACTUATED LOCKABLE FOOD STORAGE CONTAINER consisting of a sealable food storage box with a locking mechanism and removable timing device capable of enforcing a single and variable delay upon the users access to the contents of the container; U.S. Pat. No. 3,851,506 Simon, Dec. 3, 1974, which discloses a CIGARETTE BOX that makes use of an internally situated locking mechanism that causes the box to unlock after a selected period of time; and U.S. Pat. No. 5,016,453 Bonnice, May 21, 1991 which discloses a TIMED REFRIGERATOR LOCK consisting of a body mounted link chain and a door mounted shackle that is combined with a timing device capable of allowing the link chain to be detached from the shackle at a pre-determined point in time, thus allowing the refrigerator door to be opened.

Prior art devices of this type provide unnecessary and repeated means for the user to fail in his expressed desire to adhere to a pre-defined schedule of accessibility, because 1 they rely upon the will and physical action of the user to close their doors or tops; 2 they rely upon the will and physical action of the user to re-activate or engage the locked state of their doors or tops; 3 they rely upon the will of the user to resist the temptation to neglect completing either or both of those acts; 4 they rely upon the will of the user to resist the urge, impulse, or temptation to change the pre-defined access parameters; 5 they rely upon the will of the user to resist the urge, impulse, or temptation to suspend the enforcement of the pre defined access parameters; 6 they do not offer a means to exclude non-authorized persons from accessing their contents; 7 without action of the user, the container becomes open or unlocked automatically; 8 once having become open or unlocked automatically, the container remains in the open or unlocked state indefinitely until reset by the user; and 9 as a result of the preceding two failings, devices of this type require the user to interface with the device, and its contents, in order to relock the device.

Devices in this group inherently and repeatedly present opportunities or temptations for the user to change, circumvent or disable the pre-defined access parameters during normal usage and/or at easily predictable intervals. The existence of such opportunities is an unacceptable failing and/or weakness of such a device because the device inevitably will provide such opportunities during periods of weakness when the user is mentally or physically unable to resist the temptation—the existence of these periods is a given, as a consumer who does not experience such periods of weakness would have little desire to purchase and use a device of this type.

And even if a user of a device of this type is successful in resisting opportunities or temptations to change, circumvent or disable the pre-defined access parameters during normal usage and/or at easily predictable intervals, the user does so by means of the consumption of some part of his finite supply of the will to self regulate, and does thus become, after repeated attempts to resist temptation, less and less able to resist additional opportunities and temptations.

Devices presenting such opportunities are self defeating, in that they present opportunities and temptations that are too frequent, too numerous and too difficult to overcome over time, leading to inevitable failure.

Multiple Compartment and Portion Vending Machines

The desire to regulate consumption through the storage of products in containers that allow access to, or dispense, measured portions of their contents is known in the prior art, and the prior art discloses containers that either are made up of a multiplicity of individually accessible compartments or contain mechanisms capable of dispensing measured portions of their contents. This class of prior art inventions has as a defining feature in the means to dispense, or allow access to, single pre-portioned amounts of a product, either through timed access to proportioned dose, timed access to a compartment containing a single portion, or an automated mechanized measurement and dispensation of a portion.

This group includes inventions such as U.S. Pat. No. 3,762,601 McLaughlin 1973 which discloses a CABINET FOR DISPENSING MEDICINES AT PREDETERMINED TIMES consisting of a box containing a multiplicity of individually and programmably accessible compartments; U.S. Pat. No. 4,674,652, Aten, 1987 which discloses a CONTROLLED DISPENSING DEVICE making use of a tape and spool mechanism wherein pre-measured portions are affixed to a programmably advanceable tape and are made available when they align with an access port; U.S. Pat. No. 4,572,403, Benaroya, 1986 which discloses A TIMED DISPENSING DEVICE FOR TABLETS, CAPSULES, AND THE LIKE making use of an enclosed rotating toroidal tray, divided into a multiplicity of compartments, each of which is designed to accept a pre-portioned quantity of a pill or capsule. The enclosed toroidal tray revolving according to a schedule, and the contents of the individual compartments becoming accessible singly and sequentially as they become aligned with an access port; and GB 2 233 317 A, Gad, 1991 which discloses A TIMED MEDICATION DISPENSER comprised of a container consisting of a securable compartment for the acceptance and storage of a substance and a receptacle for receiving the dispensation of that substance in measured doses according to some schedule (the mechanism that would portion the output or select specific pills to dispense is not disclosed in this prior art patent).

This type of prior art inventions require the individual packaging of their contents or require that their contents be individually portioned and placed, one portion at a time, in a multiplicity of compartments. These arrangements are too time consuming for the consumer to use, too expensive to manufacture, and use a less space efficient storage method rendering them impractical for general consumer usage. Generally, products available at retail outlets are not packaged in manners that provide the uniformity required to work in these devices. Dietary portioning is a relative exercise. What may be an appropriate portion for one person may be an overdose for another. Uniform packaging is not a viable principle in this application. Additionally, the variable nature of appropriate portioning makes this approach impractical for general consumer use.

In addition, the user of a device of this type is merely a receiver for the dispensations of the device. As shown in the science, a measured and limited interaction of the user's will to self-regulate is necessary in order for the user to receive the benefits of self-reward, elevated self-image, and expanded capacity of the will to self-regulate. A device of this type does not provide for any testing of the will of the user. While such devices do not diminish the will to self regulate by tempting the user to consume, they also do not allow the user to succeed in his wishes to use his own will to self regulate, and thus exercise and enhance their will to self regulate resulting in the enhanced development and repeatability of the desired behavior. By eliminating all instances of temptation, these devices will not provide any increased volume of the will to self regulate as described in the science.

Non-Enforcing Behavior Modification Assistant

The desire to regulate consumption by means of a device which instructs the user as to the specifics of a corrected and more beneficial schedule or manner is known in the prior art. The prior art discloses devices, defined as non-enforcing behavior modification assistants, that give instruction as to the amount, constituents, speed and/or frequency of correct consumption. These devices also may in some cases impart words of encouragement. As a group, these prior art inventions are devoid of any means to enforce the indicated correct course of action, and they instead rely purely upon the will of the user to resist impulses to act counter to the offered course of action.

This group includes prior art inventions such as U.S. Pat. No. 5,673,691 Abrams, 1997, which discloses an APPARATUS TO CONTROL DIET AND WEIGHT USING HUMAN BEHAVIOR MODIFICATION TECHNIQUES, herein described as a device capable of prompting the user when to eat and exercise, and of providing suggestions as to what to eat, and requiring the inputting of actual consumption information as a means to determine a further course of action; U.S. Pat. No. 5,596,994, Bro, 1997, which discloses an AUTOMATED AND INTERACTIVE BEHAVIORAL AND MEDICAL GUIDANCE SYSTEM, herein described as a computerized system which by means of a variety of electronic collection and transmission methods and technologies is capable of collecting information about the subject user and of using that collected data to impart customized instructions as to corrected behavior and of imparting words of encouragement; U.S. Pat. No. 4,361,408, Wirtschafter, 1982, which discloses a TIMER AND ALARM APPARATUS, herein described as a device that that when attached to a freely accessible container such as a pill bottle is capable of providing scheduled alarms as prompts for scheduled consumption; U.S. Pat. No. 4,218,611, Cannon, 1980, which discloses a METHOD AND APPARATUS FOR CONTROLLING EATING BEHAVIOR, herein described as a device capable of indicating the correct tempo of eating a meal and that requires an action between each “fork full” that indicates to the device that a “fork full” has been eaten thus forcing a break in action between “fork sized” portions; and U.S. Pat. No. 5,908,301, Lutz, 1999 which discloses a METHOD AND DEVICE FOR MODIFYING BEHAVIOR, herein described as a device capable of storing multiple programs of behavior and of indicating the corresponding correct course of action. This class or group of inventions has as a defining feature the absence of any enforcement means regarding the prompted action.

The prior art inventions in this group do not provide any means for enforcement of limits placed upon the accessibility of the products and do not provide any durable and repeating means for enforcement of limits placed upon the accessibility of the products. The intended scope of this type of invention is too large and there is no enforcement of limits placed upon the accessibility of the products. By design, these inventions cause, by temptation, multiple testings and expenditures of the will to self regulate, and provide no means to provide the necessary periods of rest (periods of absence of temptations) that are necessary to enable the development of the available capacity of the will. By not limiting temptations, these devices provide multiple opportunities to fail. By not limiting temptations, these devices deplete the available will to self regulate until failure at the desired discipline results. By attempting to control a very broad scope of behaviors these devices cause the user to be repeatedly tested and thus more likely to be depleted in their ability to resist impulses to act counter to their desired behavior.

Taken as a whole, the scientific studies and discussion of prior art devices outlined above indicate that devices disclosed in the prior art which do not afford the user any durably consistent and repeating enforcement means that would aid the user in resisting the types of urges and counterproductive motivations that are the causes of the original negative behavior pattern, are not effective in durably restricting access to the content of the devices, nor in the modification of human behavior toward the development of a more desirable pattern of consumption and “willpower.

Consumers want a restricted access storage device that will effectively, consistently and even ruthlessly mandate compliance with a desirable pattern of consumption. Moreover, consumer's want to work toward developing the ability and strength (or, “willpower”) within themselves to be able to adhere to such a pattern of consumption, eventually without the assistance of a device of this type. Many consumers believe what is known by those practiced in the art; that the successful mastery of a narrow scope of positive behaviors can result in positive ramifications effecting a broad scope of other behaviors. None of the prior art devices provide the consumer with what it wants, and none present the benefits and the utility of the present invention.

3. The Current Invention'S Unique Design Characteristics Solve the Fundamental Problem.

The present invention's unique design characteristics eliminate all unnecessary opportunities to fail except for the one involving the act of portioning. As described in detail below, the desired ends are achieved through a number of design characteristics unique to the current invention, and not disclosed in any of the prior art devices, including: 1 the present invention's lid/door does not remain in the open position—during normal use it automatically closes without the assistance of the user; 2 the present invention does not need to be “re-locked” at each access event—the lid/door automatically and immediately relocks upon closure without the assistance of the user; 3 the device does not need to be opened in order for it to become “re-locked” at the expiration of an access period—the locking mechanism automatically and immediately removes access permission upon expiration of the user defined access period regardless of whether it was opened during the access period; 4 the present invention does not need to be reset after having become unlocked—the pre-defined access schedule is automatically kept in place and is durably repeated and enforced over time regardless the normal actions of the user; 5 the present invention does not allow the user to impulsively “change his mind” regarding the strictness of the regimen originally selected and inputted into the invention—access to the processor prompts that define access parameters is limited to a relatively rare and non instinctive cyclical time period that requires forethought and planning to access; 6 the present invention includes a password feature, preventing others from accessing the contents of the device or from tampering with the selected access parameters; 7 the present invention durably stores and enforces the user's original intentions over unlimited periods of time, and 8 the prompts that lead the user through the defining of their access schedule are designed to systematically present only choices that support the previously defined steps thus reducing the ability of the user to impulsively deviate from their pre-intended schedule, which is most likely and most often the schedule that the user truly wants enforced.

In the current invention, the limited opportunity for the consumer to fail in the effort to resist temptation is so diminished through elimination of all unnecessary opportunities that the user can easily and regularly overcome any secondary temptation to fail at their desired behavior path. By means of this easy success, and by means of the absence of any other opportunities to fail in their desired behavior path, the user is more likely to succeed and in doing so receive positive reinforcement of his ability to succeed at self-regulating his consumption.

Thus, the present invention both mandates compliance with the restricted access pattern selected by the consumer when he had his best intentions and long term health in mind, and assists the consumer in preserving, and indeed developing through limited exercise, the consumer's limited supply of willpower.

And through the use of a password feature, the current invention allows the user to prevent access to the contents of the device by all persons other than the user. None of the prior art devices disclose this capability.

### EXAMPLES OF APPLICATIONS OF THE CURRENT EMBODIMENT OF THE INVENTION

Discussed here are a few examples demonstrating use of the device in ways not available with the prior art devices. There are many other unique uses not listed here—the following are merely a few examples:

### Example 1

A user can decide that once the device becomes unlocked making the contents accessible, the user will in an instant lift the lid/door, take a portion of the product within it, and then immediately let the lid/door drop, thus triggering the auto lock mechanism. This requires virtually no effort from the user (no requirement to reset the device, or to physically lock it), no decision from the user other than to not take action to not allow the lid to drop, and results in a successful exercise of the will to self regulate, of a very limited duration. Usage of the invention in this manner precludes impulsive re-portioning brought about following the consumer tasting the portion, triggering a heightened desire for more, and thus defeats the very idea behind advertising campaigns such as “bet ya can't eat just one.”

### Example 2

The user has only to resist temptation during the life of each access period (selected by the user when he set the device) and, without any further action, decision or conduct, the access period automatically expires and the device becomes locked again. Most notably, the lack of necessity for the user to interact with the device, and thus with its contents, eliminates unnecessary and painfully acute temptation resulting from that interaction.

### Example 3

A user can decide that once the device becomes unlocked, the user will in an instant lift the lid/door without taking any of the contents, and immediately let it drop, thus triggering the auto lock mechanism. This requires virtually no effort from the user (no requirement to reset the device, or to physically lock it), and results in a successful exercise of the will to self regulate, of a very limited duration. And once the lid drops, the user is unable to change his mind an gain access to the contents.

### Example 4

A user can decide to program the device so that its defined periods of accessibility occur when the user is not generally in proximity with the device, allowing other persons to have access to the contents of the device in a way that does not deprive the user of the ability to be free from exposure to the contents of the device.

### Example 5

A user can decide to program the device so that its defined periods of accessibility occur only when the user is generally in proximity with the device. In this way a user could ensure that others will not have unsupervised access to the contents of the invention when the user is not present. For “latchkey children” for example, the child's snacking habits could be controlled and modified by the ability of the invention to require the presence and permission of the householder to be able to access the contents of the invention.

### Example 6

A user (e.g., an office worker) may wish to keep a supply of a favorite snack on-hand, but only to be consumed at a certain time of day by the consumer, but not by others (e.g., co-workers). Through the durable timed access restriction, as well as the password feature, the present invention has this capability.

These are just a few examples of the types of uses to which the present invention can be put, that are not possible with the prior art devices.

### SUMMARY OF THE INVENTION

The invention is comprised of a storage container for food that has as separate components, a container, and a lid/door assembly that is detachable from the container for the purposes of cleaning the container and for accessing the power supply.

The lid door assembly consisting of an multi-piece outer casing that houses multiple components that together enable the lid/door assembly to be capable of accepting, storing, and enforcing, the users specified schedule of multiple, cyclically occurring, windows of opportunity, of user definable duration, concerning the availability/accessibility of any product that can be contained within its attached container.

The lid assembly components consisting of its casing, a power supply, an electronic programmable processor assembly with non-volatile memory capability, a button set, a display component, and an electro-mechanical locking mechanism and a power supply.

All of the parts that make up the invention are part of the lid/door assembly except for the container which has as its only special features 1 molded shapes in the upper container rim that allow it to mate in a low friction way with corresponding moldings in the case of the lid door assembly in such a way that there is a pivoting hinge relationship between the two components when they are correctly aligned and pressed together, and 2 other molded shapes in the upper container rim that allow for the acceptance and capture of protruding locking bars that are part of the lid/door assembly and that protrude from lid door assembly through openings in its casing in such a way as to be captured by these moldings in the upper container rim when the lid/door assembly becomes closed.

The lid/door assembly is unable to be left open in that its degree of motion is limited so that gravity will automatically close it when it is released from the hand.

The locking mechanism is constructed in such a way that the automatic closing of the lid also effects an instantaneous locking of the lid/door assembly.

The users stored desired schedule of accessibility is enforced by the inventions permanent behaviors, that are part of the design of the invention, in such ways as to remove all reasonable possibility of accessing the contents of the attached container except during a window of opportunity as defined by the user at the time that they programmed their desired schedule into the invention. This preclusion of opportunity results in reductions of opportunities to fail on the part of the user in their stated and defined desire of adhering to a strict schedule of accessibility regarding the contents of the invention. This beneficial reduction in the opportunities to fail resulting in an elevated level of adherence to the user defined schedule of accessibility and in a reduction of consumption of will power on the part of the user resulting in multiple and novel benefits to the user as described and explained in the background section of this document. These benefits are not found in the prior art.

Some of the reductions in opportunities to fail are the result of mechanical features and some are the result of programmed behaviors inherent to the operation of the invention.

Mechanical, electromechanical, and electronic features that contribute to the reduction in opportunities to fail include;
Its automatic closing functionality;
Its automatic locking functionality;
Its instantaneously locking upon becoming closed functionality;
Its ability to durably store all parameters despite the total depletion of the power source;
Its ability to sense a decrease in battery voltage and ability to use that sensed data as an indicator to prompt the user to change the batteries resulting in a greater likelihood that the user will be able to continue to use the device;
Its ability to sense the position of the lid in relation to the containers upper lid assembly.

Programming (software) features that contribute to the reduction in opportunities to fail include;
Its ability to prompt for and durably store data equivalents of the users designed and desired schedule regarding the accessibility of the contents of the invention;
Its ability to control the locking mechanism in such a way as to permit access strictly in accordance with the users designed and desired schedule and to extent that enforcement durably over time;
Its ability to automatically cycle the lock to the locked position immediately upon the action of the lid/door assembly being lifted;
Its ability to prompt the user for inputs regarding the definitions of multiple, cyclical, windows of opportunity of varying durations concerning the accessibility of the contents of the invention;
Its ability to prompt the user for inputs in a manner designed to eliminate opportunities to waver in their pre-determined intentions concerning the accessibility of the contents of the invention;
Its requiring an input by the user in order for the device to become unlocked;
Its ability to “expire” programmed periods of accessibility that are not made use of;
Its ability to optionally store and enforce a security feature where in the user defines and stores a security code that the invention will require input of in order for the user to be granted access to the contents of the invention;
Its ability to deny re-programming opportunities except at a predetermined cyclical interval designated by the inventor as being non-instinctive and not easily anticipated. Other behaviors;
Its ability to determine that it has not been accessed for an extended period of time long enough, as determined and programmed by the inventor, to indicate either a disinterest in continuing the current program of accessibility or of indicating that the optional access code has been lost. In this case the invention cycles to the open state and resets thus allowing a new user to begin the programming phase or the existing user to re-select their programming and reassign an access code;
Its ability to sense a low power situation and if the user does not respond to promptings to replace the batteries to anticipate a critical voltage decrease and cycle the invention to the open state before it can be subjected to a “no power lockout” wherein there is no way to open the invention in order to access the interior accessible battery port;
Its programmed behavior, in the current iteration, of not giving any indication that a period of accessibility is current.

### DESCRIPTION OF DRAWINGS

FIG. 1 shows a perspective view of the exterior appearance of the present invention with its main exterior features named and enumerated

FIG. 2 shows an exploded view of the present invention with its important components and features named and enumerated.

FIG. 3 shows a view from above of the bottom lid door casing, the container rim moldings, and the electromechanical locking mechanism, with their main features and components named and enumerated.

FIG. 4 shows a side view of the lid/door assembly casing with a separate detail of its hinge arrangement with their main features named and enumerated and a side view of a container rim molding with hinge molding and other features named and enumerated.

### DETAILED DESCRIPTION

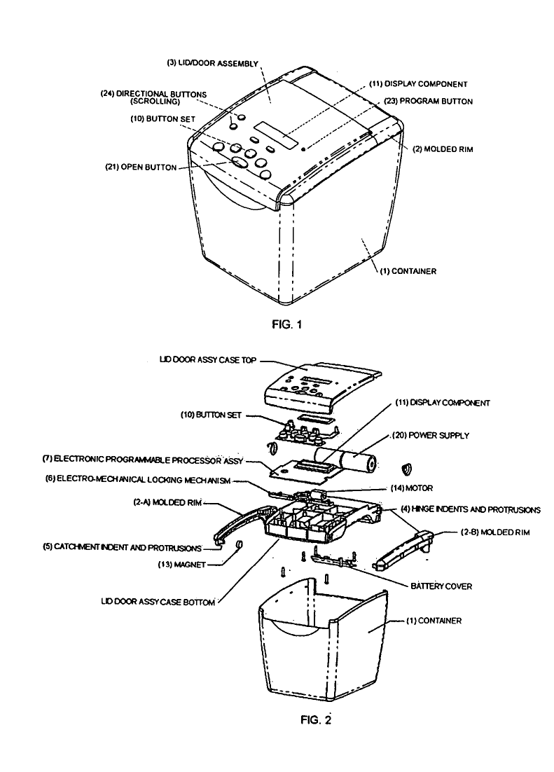

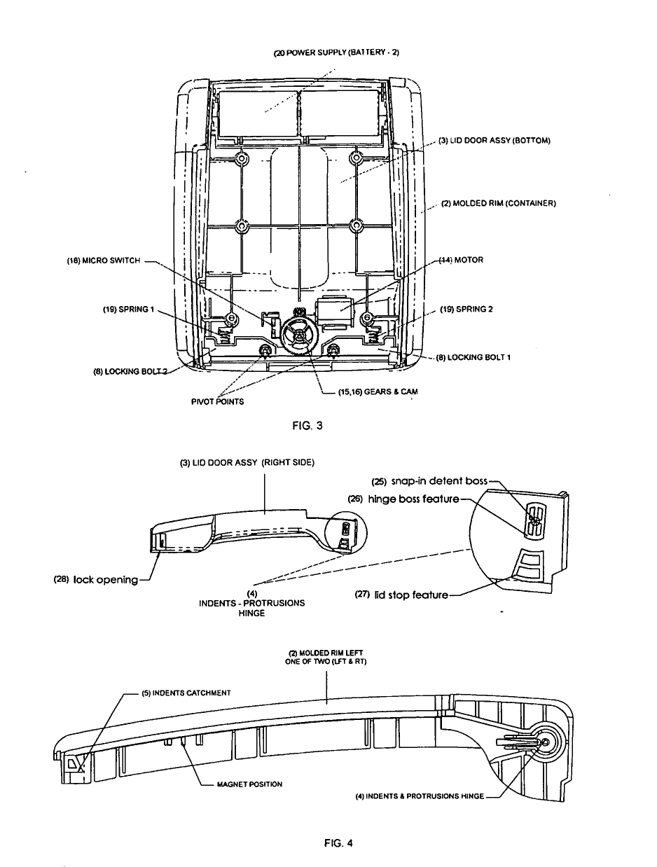

In accordance with the objects of the invention, in the current preferred embodiment (as shown in FIG. 1) of the invention there is provided: a container 1 comprised of 4 walls (or a single cylindrical wall), a floor, and a molded container rim 2 designed to accept and receive an optionally removable and normally hinged locking lid/door assembly 3 that is capable of locking into the closed position and thus precluding access to the contents of the invention.

The molded container rim 2 and lid/door assembly 3 having indentations and protrusions consisting of indents and protrusions hinge 4, snap-in detent boss 25, hinge boss 26, lid stop 27, arranged and shaped in such a way as to provide for a pivoting, removable, hinge arrangement so that the lid/door assembly 3 may be removed completely from attachment to the molded container rim 2 by means of pressure applied in such a way that when the lid/door assembly 3 is lifted to a predetermined position it is able to be removed from its attachment to the molded container rim 2 In a reverse procedure the lid/door assembly 3 can be returned to its attachment to the molded container rim 2 by sliding it into the correct position and applying correct pressure resulting in a “snap in” fit that is of a low friction nature.

The molded container rim 2 having indentations (catchments) 5 arranged and shaped in such a way as to provide for the acceptance and capture of the locking bolts 8 that are part of the lid/door assembly's 3 electro mechanical locking mechanism 6 and in such a way as to allow for the low friction passage of the locking bolts 8) into their respective indentations (catchments) 5 regardless the locking bolts state or position.

The lid/door assembly 3 containing an electro mechanical locking mechanism 6 connected to and controlled by the electronic programmable processor assembly 7, and able to move two protruding locking bolts 8 in and out of the locked position according to the designed behavior that, in consideration of the angular position of the lid/door assembly 3, prepares in advance the lid/door assembly 3 to be instantly locked into position when it is allowed to fall into the closed position or is otherwise closed.

The electronic programmable processor assembly 7 being comprised of an electronic processor, electronic memory, button set 10, display component 11, and other components, arranged, attached, and connected in such a way as to be capable of prompting for and durably storing data reflecting the users desires concerning the accessibility of the contents of the invention, within the framework of the behaviors allowed by the data stored in the permanently stored data set as defined and stored by the inventor.

The electronic programmable processor assembly 7 being arranged, attached, and connected in such a way as to be capable of controlling the electromechanical locking mechanism in a manner reflecting data stored in the permanently stored data set, the user defined data set, and the security data set.

The lid/door assembly 3 being capable, when correctly attached to the molded container rim, of falling into the completely closed position by means of gravity, by means of a low friction hinge arrangement, and by means of the low friction spring loaded action of the locking bolts 8 which are able to slide over the receiving catchments 5 that are molded into the upper rim of the receptacle, and of then instantaneously and positively locking into the closed position.

The lid/door assembly 3 containing an electronic programmable processor assembly 7, being capable, by means of a display component 11, of displaying textual prompts generated from and capable of accepting and storing user inputs into, the programmable electronic processor assembly 7.

The lid/door assembly containing an user accessible Button Set 10 for the purpose of enabling the user to input the chosen and prompted for parameters that make up the stored user defined data set, and for entering the input(s) that are prompted for and/or required by the invention, during normal usage of the invention, before access is allowed.

The lid/door assembly 3 containing a magnet sensor capable of determining the proximity of a magnet 13 that is securely and permanently placed in a corresponding position in the upper rim of the receptacle that is within the sensory limits of the magnet sensor when the lid/door is in the closed position.

The lid/door assembly 3 being unable, due to the design and shape of the device, to be opened to a degree sufficient to allow it to remain in the open position such that the lid/door assembly 3, when in the open position falls automatically into the closed position unless held in the open position by the user. This self closing behavior working in conjunction with the automatic locking actions of the electronic programmable processor assembly 7, magnet 13 arrangement, and electromechanical locking mechanism 6 to provide for an automatic closing and locking action that is effected by the release of the lid/door assembly 3 from the users hand requiring no other action by the user to be completed.

The electromechanical locking mechanism 6 consisting of a motor 14, cam & gears 15 & 16, locking bars 8, micro-switch 18, and springs 19 in such a way as to be capable of a cyclical locking and unlocking action and depending upon the electrical motor 14 to cycle the lock. The locking bars 8 being spring loaded so that when they are in the locking position they may be depressed, against the load of a spring, into the unlocked position, thus allowing the locking bars 8 so slide along the locking latch catchment 5 and drop into the locked position. This functionality allows the lid/door assembly 3 to be placed in the closed position while the locking bars 8 are in the locked position and is essential to the automatic closing and locking action of the invention.

The electronic programmable processor assembly 7 being capable of using the data provided by the magnetic sensor to determine the proper necessary position of the locking bolts 8 such that the locking bolts 8 are placed into the locked position immediately upon the users act of lifting of the lid/door assembly 3 causing the magnet 13 to be removed from relative proximity to the magnet sensor.

The electronic programmable processor assembly 7, contained within the lid/door assembly 3, being capable of accepting a set of inventor defined operational variables, (“permanently stored data set”) that controls and defines the operation of the connected electromechanical locking mechanism 6 in such a manner as to provide an semi-automated locking/unlocking action that either holds the lid/door assembly 3 in a closed position while the lid/door assembly 3 is in a closed position, or does not hold the lid/door assembly 3 in a closed position while the lid/door assembly 3 is in a closed position, as scheduled by, and in accordance with, the user defined set of operational variables (“user defined data set”) and upon either an “open” button 21 being pressed or, an access code being entered.

The electronic programmable processor assembly 7 presenting, by means of the display component 11, a textual user interface, constructed and arranged in such a way as to provide to the user a simple manner of recording and storing their chosen input variables, as prompted for by the electronic programmable processor assembly 7 as displayed by the display component 11 from data contained in the permanently stored data set, and as constructed and arranged in such a manner as to not present to the user options and variables that do not apply to previously completed programming steps that have been stored in the user defined data set during the current programming session.

The electronic programmable processor assembly 7 being capable of making use of the display component 11 and button set 10 for the purpose of prompting for, accepting, and storing in the user defined data set, data as defined and input by the user.

The electronic programmable processor assembly 7 being capable of controlling and working in conjunction with the other active components of the electro-mechanical locking mechanism 6 in such a way as to enforce the parameters of the user defined data set as chosen, designed, defined, and input by the user, without any further involvement of the user, over a considerable period of time. Said period of time being limited only by the durability of the device and upon the requirement that the user to refresh the power supply 20 when it becomes expended. (In this iteration the power supply 20 is comprised of batteries but there exists the possibility in other iterations for the use of alternate power sources).

The electronic programmable processor assembly 7 being capable of storing all data sets in the non-volatile memory component of the electronic programmable processor assembly 7 so that all data sets can be durably enforced beyond the exhaustion of the units power supply 20.

The Button Set 10 consisting of an array of protruding, user actuate-able buttons including one “open button 21”, one program button 23, two directional buttons 24, and a multiplicity of other buttons for the purposes of, opening the invention, defining and entering access codes, and for effecting the entering of data into the user defined data set.

The power supply 20 being accessible by the user only when the device is in the open position and normally only easily accessed by the removal of the lid/door assembly 3 from the container.

The operational procedures inherent to the invention, by means of the permanently stored data set, causing the invention to behave in manners designed to reduce opportunities to fail regarding the users wishes as represented by their inputs to the user defined data set. These behaviors include; (A) the electromechanical locking mechanism 6, after having become unlocked in response to the correct and timely input by the user, returns to the locked position immediately upon the lid being lifted by the users action; (B) the electromechanical locking mechanism 6 does not become unlocked unless an appropriate and timely input is entered by means of the button set; (C) the invention does not respond to any input by the user unless a period of accessibility, as defined by the user in the user defined data set, is current; (D) said periods of accessibility do expire, according to the parameters of the user defined data set, so that even if the invention is not accessed during a period of accessibility, any subsequent attempts to access the contents of the invention that do not occur during a correct and current access period, will be denied; (E) only a single access will be allowed in any period of accessibility; (F) the ability to reprogram the invention, or in any way alter the parameters of the user defined data set, is disabled unless and until a designated programming period is current, said period of time being, as devised and implemented by the inventor, a cyclical event of limited duration that occurs in a cycle not easily anticipated or aligned with any specific day of the week; (G) data is collected by the invention for inclusion to the user defined data set by means of prompts that are displayed by the display component 11 in groups designated as mode prompt sets. Mode prompt sets, each being a sub-set of the group of all existing stored prompts and being the list of prompts that are presented to the user as the means of collecting data to be included in the user defined data set; (H) data collected by the invention for inclusion to the user defined data set is done by means of a mode prompt set so that any prompt that is proffered to the user is applicable to the mode that has been chosen by the user, resulting in a programming path that excludes opportunities and temptations for the user to change their original, primary, and most likely preferred, data choices; (I) In the present iteration of the invention there are 5 mode prompt sets, corresponding to 5 modes of operation, each of which reflects a different general mode of behavior designed to reflect different modes of behavior that are commonly desired by users of such a device. These modes of behavior each allow for different combinations of (a) the number of periods of access in each 24 hour period and (b) the requirement or non-requirement of a security code for access to the contents of the invention; (J) If a mode that makes use of a security code is chosen by the user, and a security code entered into the security data set, then the invention will not open or allow re-programming without prompting the user for their security code. If the security code is not entered when prompted for, the invention will not open or allow re-programming; (K) if the invention is not accessed for a period of time that is great enough, as defined and stored by the inventor, to indicate that its user either does not wish to continue using the device or that the user has lost or forgotten the access code, then the invention resets and unlocks, thus allowing a new user to begin to use the device or the original user to redefine their password and reestablish their pattern of usage; (L) Because the present iteration of the invention makes use of a battery power source there is a combination of a voltage sensor and programming that results in the user being prompted to replace the batteries when their output falls below a certain threshold. At this prompting the invention is still able to function normally. Should the user ignore the prompting to replace the batteries, and the output become so low as to possibly create a “no power lockout” wherein the devices electromechanical locking mechanism does not have enough power to unlock the device, the invention will become unlocked and stop operation until the batteries have been replaced. In this and all situations involving the loss of power, the data in the permanently stored data set, user defined data set, and security data set is preserved.

The electronic programmable processor assembly 7 having a non-volatile data storage capacity configured and connected to the other components of the invention in such a way as to be able to durably store and make accessible to the electronic programmable processor assembly 7(a) the permanently stored data set comprised of data concerning and controlling the permanent operational behaviors of the invention, (b) the user defined data set comprised of data concerning the schedule of accessibility as designed and input by the user, and (c) the security data set comprised of data concerning the optional security code information if such code is being used by the user The user defined data Set being a group of operational variables, constructed, arranged, displayed, and manipulated in such a manner as to provide to the user a manner of defining and storing periods of time that when stored, accessed, and acted upon by the electronic programmable processor assembly 7 will provide an arrangement wherein the user will be able to access the interior contents of the container, by means of the locking/unlocking action of the connected electro-mechanical locking mechanism 6 and electronic programmable processor assembly 7, strictly in accordance with the users wishes as stored in the user defined data Set.

The user defined data set being a group of operational variables that are derived from the responses to prompts designed to create a data set corresponding to and capable of faithfully recording parameters equating to, in this iteration of the invention, the following set of questions, instructions, and explanations;
Step 1. Define the current time of day.
Step 2. Select Mode
Mode 1—A single access opportunity per day.
Mode 2—A single access opportunity per day, with access code.
Mode 3—Multiple access opportunities per day.
Mode 4—Multiple access opportunities per day, with access code.
Mode 5—Anytime access, with security code.

If the user selects Mode 1, the user will be prompted to define the start and end times of the single access opportunity.

If the user selects Mode 2, the user will be prompted to define the start and end times of the single access opportunity and then the user will be prompted to define a 4 digit security access code.

If the user selects Mode 3, the user will be prompted to define how many access opportunities the user wishes to define and then the user will be prompted to define the start times and end times of each access opportunity.

If the user selects Mode 4, the user will be prompted to define how many access opportunities the user wishes to define and then the user will be prompted to define the start times and end times of each access opportunity and then the user will be asked to define an four digit security access code.

For instance, If the user selects Mode 1 and the user defines an access opportunity that starts at 5:00 P.M. and ends at 6:00 P.M. the user will be able to open the container one time during that window of access. When the user has opened the SnackSafe and removed the users chosen portion of the contents of the device, the SnackSafe door will close and lock automatically and will not be able to be opened again until the next day between 5:00 and 6:00 P.M.

If the user selects Mode 2, the operation of the device will be the same as in Mode 1 except that the user will be prompted to enter the users access code before the user will be allowed to open the door and access the contents of the device.

The operations Modes 3 and 4 are similar except that the user will have multiple opportunities to access the contents. In all cases, the user can only access the contents one time during any single defined access window.

Mode 5 is designed to allow the user to use the SnackSafe as a safe. The user can access the contents of the SnackSafe at any time by inputting the security code.

### Re-Programming in the Preferred Embodiment

No re-programming will be allowed unless and until a programming opportunity is active. A programming opportunity is indicated by the appearance of an icon in the devices display component. In this iteration, programming opportunities occur every 9 days from the date of the last programming. Programming opportunities are, in this iteration, of 24 hours duration. If a user does not press the Program button 23 during the active programming opportunity, the programming opportunity will expire, and the previously defined program will remain in force. Pressing the Program button 23 during an active programming opportunity allows the user to alter all parameters, beginning with the basic operating mode as defined at the beginning of this discussion.

Inherent Behavioral Characteristics of the Current Embodiment

When the integral processor determines that the time of day corresponds to a period of accessibility as defined by the user in the programming procedure, the device will respond to attempted inputs by the user in one of two ways;
If the user has chosen modes 1 or 2 then a single press of the open button 21 results in the device unlocking and thus allows the user to lift the lid/door assembly 3 and access the contents of the device.

If the user has chosen modes 3, 4, or 5, then a press of the open button 21 results in a prompt for the user's entry of the defined access code. When the user responds by pressing the numbered buttons that are part of the button set 10 in the correct order the unit responds by unlocking and thus allows the user to lift the lid/door assembly 3 and access the contents of the device.

In either instance, the lifting of the lid/door assembly 3 causes the electromechanical locking mechanism 6 to cycle itself to a locked state. This locking action actually occurs immediately upon the user lifting the lid/door. Thus, when the device's lid/door assembly 3 is allowed to drop into the closed position, its mechanism is pre-locked. This allows for instantaneous closing and locking.

In either instance, the lifting of the lid/door assembly 3 terminates the period of accessibility. The device cannot be re-opened, after being allowed to close, until the next programmed period of accessibility is active.

If the device is not in an active period of accessibility it does not respond to any inputs by the user.

In no way does the device, in this iteration, give an outward indication that a period of accessibility is active or approaching. In this iteration of the invention, the users own memory of his or her decisions concerning the periods of accessibility provides the only information that the user will have concerning the programmed periods of accessibility. This is intended to protect the user from unwanted and unnecessary temptations in that, if the user does not want to access the contents of the device, they will not be prompted to do so by any functionality of the invention. Additionally, this designed passivity makes it less likely that another person will access the contents of the invention should the user opt for a mode that does not require a security code.

1. A storage container for rigid control of access by users comprising:
a housing;
a cover hingedly attached to the housing;
a lock incorporated into the cover for locking the cover to the housing;
the lock being programmed to automatically reset to the locked mode when the cover is opened and to immediately lock the cover to the housing upon closure;
programming means for controlling the lock for defining periods of accessability and inaccessability and;
a power supply for providing electric power to the programming means.

2. A container according to claim 1 wherein the lock comprises an electromechanical mechanism.

3. A container according to claim 2 wherein the mechanism comprises one or more retractable bolts.

4. A container according to claim 3 wherein the lock comprises two reciprocating bolts which move in opposite directions to lock the cover to the housing.

5. A container according to claim 1 wherein the cover is detachable from the housing.

6. A container according to claim 5 wherein the cover includes shaped protrusions extending from one side of the cover.

7. A container according to claim 6 wherein the housing includes detents for receiving and gripping the protrusions on the cover.

8. A container according to claim 2 wherein the engagement of the protrusions and detents is by means of a snap fit.

9. A container according to claim 4 wherein the rim of the housing includes receptacles adapted to receive the reciprocating bolts.

10. A container accounting to claim 1 wherein the programming means is a programmable microprocessor operatively connected to the cover.

11. A container according to claim 10 wherein the programming means includes a processor assembly incorporating the microprocessor, an electronic memory, control keys, and a display for receiving and displaying the parameters incorporated into the container.

12. A container according to claim 8 wherein the housing and cover include mutually engaging stops to prevent travel of the cover more than 700 from the closed position.

13. A container according to claim 8 wherein the hinged connection is configured to limit travel of the cover and to return to the closed position under the force of gravity.

14. A container according to claim 4 wherein the bolts are spring-loaded.

15. A container according to claim 14 wherein the bolts retract at the predetermined programmed intervals under the control of the user.

16. A container according to claim 15 wherein the bolts extend and engage the housing upon closure of the cover onto the housing.

17. A container according to claim 1 wherein the power supply is incorporated into the programmable processor assembly.

18. A container according to claim 17 wherein the power supply is only accessible when the cover is in the open position.

19. A programmable, automatically closing, and automatically locking storage container for rigid control of access to its contents by users, comprising:
a housing;
a cover, said cover being attached to said housing by hinged moldings;
a computer controlled lock incorporated into the cover for locking the cover to the housing to prevent unauthorized access to the contents of the container;
the lock being configured to automatically reset to the locked mode when the cover is opened and to immediately lock the cover to the housing upon the closure of the cover;
a programmable computer incorporated into the container for controlling the lock, said programmable computer being programmed to accept and store multiple variables and parameters for defining periods of accessibility and inaccessability of variable duration; and
a power supply that can be accessed only when the cover is in the open position.
